(19) United States
(12) Patent Application Publication
(10) Pub. No.: US 2006/0018661 A1
(43) Pub. Date: Jan. 26, 2006

(54) Alignment system

(76) Inventors: Edward Alan Green, Cambridge (GB); Burn Morrison, Cambridge (GB); Andrew White, Cambridge (GB); Nicolas Vasilopoulos, Cambridge (GB); Roger Nixon, Cambridge (GB); Laln Howieson, Cambridge (GB)

Correspondence Address: Galgano & Burke, 300 Rabro Drive, Suite 135, Hauppauge, NY, 11788, US

(21) Appl. No.: 10/506,141

(22) PCT Filed: Mar. 4, 2003
(86) PCT No.: PCT/GB03/00879

§ 371 Date: Aug. 22, 2005

(30) Foreign Application Priority Data
Mar. 4, 2002 (GB) 01255942

(51) Int. Cl. H04B 10/00

(52) U.S. Cl. 398/128

(57) ABSTRACT

A free space point-to-point signaling system is described in which optical beams generated by two free space transceiver units are optically aligned with each other using beam steering techniques. Once aligned, each transceiver unit detects the received signal strength and transmits this information to the other transceiver unit. This information is used by the other transceiver unit to vary the signal strength of the beam that it transmits and to optimise the alignment between the light beams transmitted by the two transceiver units. The determined received signal strength measure is also used to detect if the two transceiver units have become misaligned or if the beams have been interrupted, so that the transmission power can be reduced if necessary or so that the alignment procedure can be restarted.

The present invention relates to a signalling system. The invention has particular, although not excusive relevance to an alignment system used to align free space optical beams used in an optical communication system.

Free space optical communication systems are becoming increasingly popular as an alternative to optical fibre in high bandwidth, short range applications, due to their lower installation cost and their ease of installation.

In a conventional point-to-point free space optical communication system, each link is formed between two optical transceiver units. Relatively divergent laser beams may be used between the transceiver units in order to ease alignment during installation and to allow the transceiver units to move over time while still maintaining the link. However, the use of such diverging laser beams increases the optical loss which, for a given optical transmitting power, reduces the range or availability of the link. It is possible to overcome this problem by using optical beams having low divergence. However, this requires more accurate alignment between the two optical transceiver units.

Automatic systems have been proposed to provide the initial alignment and to maintain alignment during operation, but these systems can be complex (for example using global positioning systems (GPS) to point each transceiver unit at the known co-ordinates of the other), expensive and in many cases have limited accuracy. The time required to achieve alignment (the so-called acquisition time) can also be relatively long.

According to one aspect, the present invention aims to provide an alternative system to automatically align two free space optical signalling units.

According to one aspect, the present invention provides a free space optical signalling system in which one or more optical transceiver units includes an optical transmitter for generating and for transmitting an optical beam to another optical transceiver unit and an optical receiver for receiving light from the other transceiver unit; and a separate retro-reflector having a telecentric lens for reflecting light transmitted by the other transceiver unit back to the other transceiver unit for use in aligning the two transceiver units. By using a retro-reflector having a telecentric lens, the beam divergence of the retro-reflected light can be minimised thereby minimising the optical losses experienced by the retro-reflected light beam.

In a preferred embodiment, each transceiver unit includes a circuit for calculating the average signal strength of the light received by the optical receiver, which information is used to control the transmission power of the optical transmitter. This allows the optical transceiver to reduce the power if it detects a sudden reduction in the received signal strength indicating that there is a blockage between the two optical transceivers.

In a further preferred embodiment, the value of the received signal strength calculated at each transceiver unit is transmitted to the other transceiver unit and is used to optimise the alignment between the two transceiver units.

According to another aspect, the present invention provides an optical free space signalling system in which at least one free space optical transceiver includes a circuit for determining the received signal strength and a transmitter for transmitting the received signal strength value to another free space optical transceiver of the system, which other free space optical transceiver is operable to use the received strength indicator to control an optical alignment between the optical transceivers.

According to another aspect, the present invention provides an optical free space system in which at least one free space optical transceiver includes a circuit for determining the received signal strength and a transmitter for transmitting the received signal strength value to another free space optical transceiver of the system, which other free spaced optical transceiver is operable to use the received signal strength value to control the optical transmitting power of the other optical transceiver.

According to a further aspect, the present invention provides an optical free space signalling system in which at least one free space optical transceiver includes a circuit for determining the received signal strength and a power control circuit which is operable to control the power of a transmitted optical beam in dependence upon variations in the determined received signal strength.

The present invention also provides optical free space transceiver units for use in the above signalling systems.

Embodiments of the invention will now be given by way of example only with reference to the accompanying drawings in which:

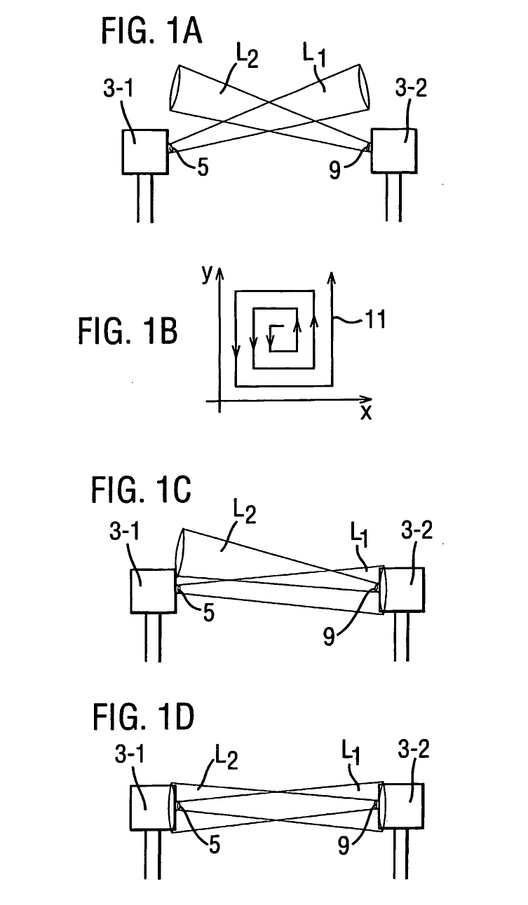

FIG. 1A is a schematic diagram illustrating two free space optical transceiver units which are not aligned with each other;

FIG. 1B illustrates a scanning pattern which is used by the transceiver units shown in FIG. 1A to scan the transmitted optical beams over a scanning area;

FIG. 1C is a schematic diagram illustrating an initial alignment of one of the transceiver units with the other transceiver unit;

FIG. 1D is a schematic diagram illustrating the two transceiver units shown in FIG. 1A when they are both optically aligned with each other;

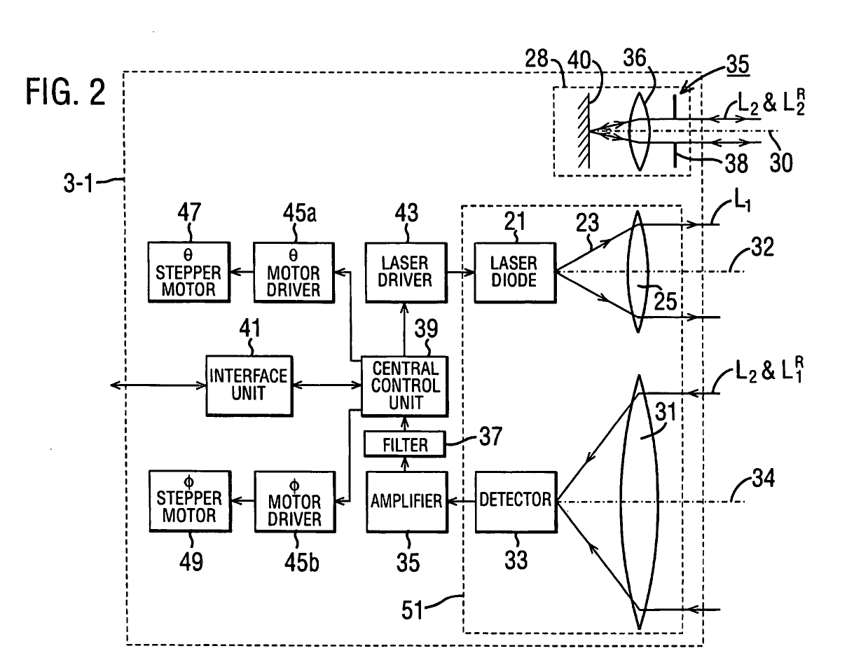

FIG. 2 is a schematic block diagram illustrating the main components of one of the transceiver units shown in FIG. 1;

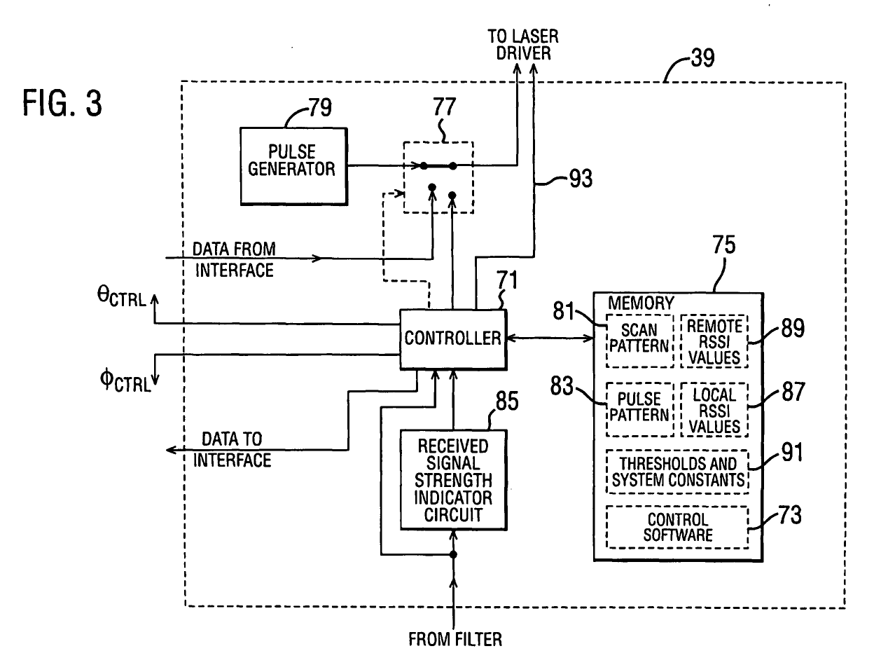

FIG. 3 is a schematic block diagram illustrating the main components of a central control unit forming part of the transceiver unit shown in FIG. 2;

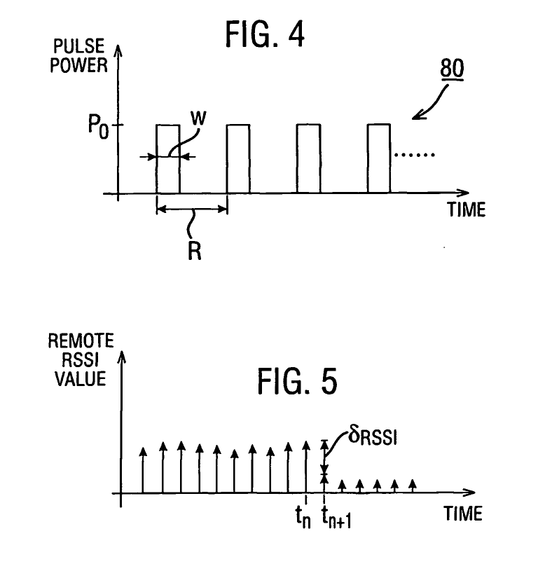

FIG. 4 is a timing diagram illustrating a sequence of pulses generated by a pulse generator forming part of the control unit shown in FIG. 3;

FIG. 5 is a time plot illustrating the way in which a received signal strength indicator value varies with time;

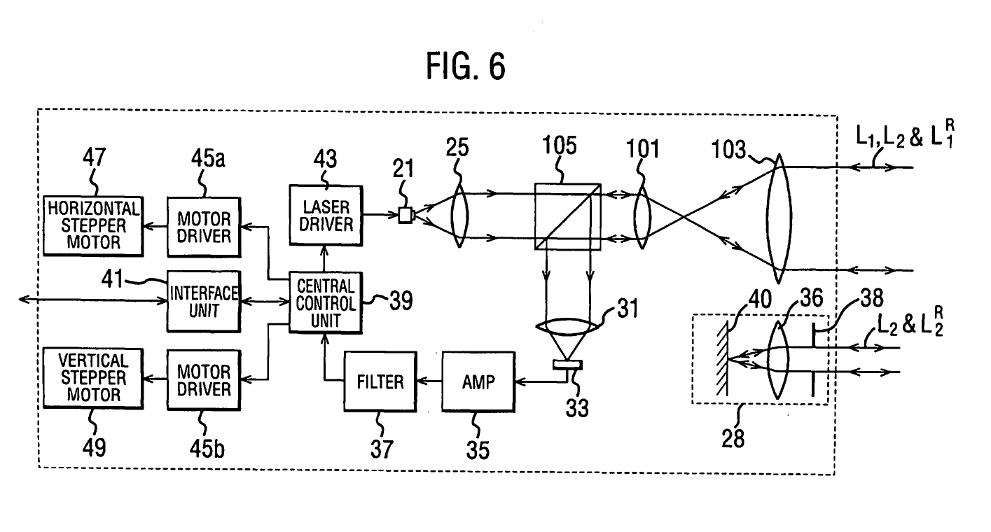

FIG. 6 is a schematic diagram illustrating the main components of an alternative transceiver unit in which the transmission and reception circuits share common optics; and

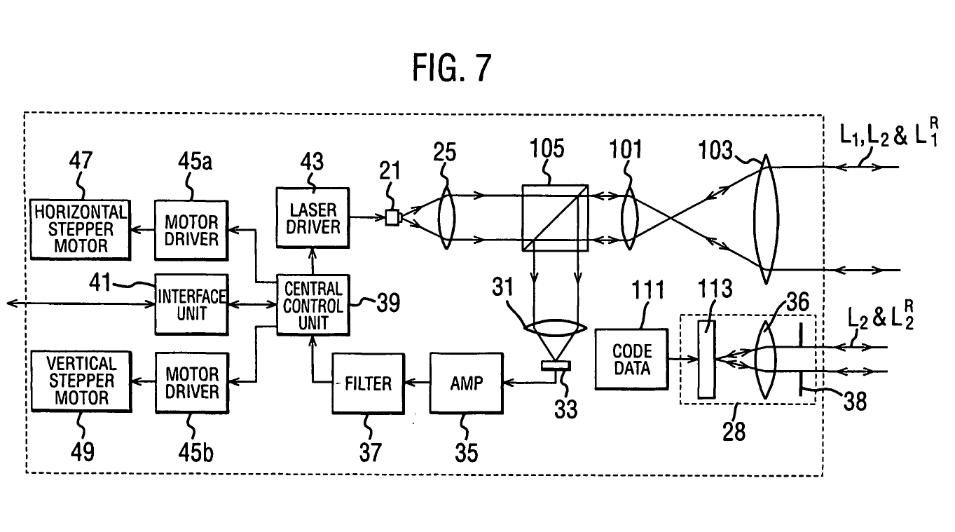

FIG. 7 schematically illustrates the form of a further alternative transceiver unit having a retro-reflecting modulator unit.

### FIRST EMBODIMENT

FIG. 1A schematically shows a first transceiver unit 3-1 which is operable to generate and to output a light beam L₁ from an optical window 5 provided in the side of the transceiver unit 3. FIG. 1A also shows a second transceiver unit 3-2 which is also arranged to generate and to output a light beam L₂ from an optical window 9 on the side of the transceiver unit 3-2. As shown in FIG. 1A, the two optical transceiver units 3 are not aligned with each other since optical transceiver unit 3-2 does not fall within the light beam L₁ and similarly optical transceiver unit 3-1 does not fall within the light beam L₂.

The problem of initial alignment of a free space optical communication system such as the one shown in FIG. 1A is therefore mainly concerned with the determination, at each transceiver unit 3, of the angular position of the other transceiver unit 3 with sufficient accuracy for the optical link to be established. In this embodiment, each of the transceiver units 3 includes steering motors (not shown) which are used to steer the transmitted light beams over a predetermined steering range. In this embodiment, two steering motors are provided in each transceiver unit 3 which rotate the transceiver unit 3 about two orthogonal axes. The angular range of steering afforded by these steering motors will, in general, be limited to some value in each axis (θₘₐₓ, φₘₐₓ) which defines the maximum steering range of the transceiver units 3.

During the installation of the transceiver units 3 they are initially manually aligned so that they are pointing at each other within the steering range (θₘₐₓ, φₘₐₓ) of the steering motors. Provided θₘₐₓ and φₘₐₓ are sufficiently large (e.g. of the order of +/−5°), then this initial alignment can be achieved by a human operator using a relatively simple optical sight. Once this initial manual alignment has been performed, each transceiver unit 3 is set into an acquisition mode in which the steering motors are used, under processor control, to scan the transmitted light beam over the steering range of the steering motors until the two transceiver units 3 are aligned. In this embodiment, the steering motors cause the transmitted light beam to be scanned over a spiral scan pattern, such as the scan pattern 11 shown in FIG. 1B.

In this embodiment, each of the transceiver units 3 also includes a retro-reflector (not shown) which operates to reflect light back in the direction from which it came. Therefore, when the light beam L₁ from the first transceiver unit 3-1 hits the retro-reflector of the second transceiver unit 3-2, the light beam is reflected back to the first transceiver unit 3-1 indicating to the first transceiver unit 3-1 that it has aligned itself with the other transceiver unit 3-2. FIG. 1C schematically illustrates this situation when the first transceiver unit 3-1 is aligned with the second transceiver unit 3-2. At this stage, the first transceiver unit 3-1 stops the scanning operation and waits a predetermined period of time to allow the second transceiver unit 3-2 to become aligned with the first transceiver unit 3-1, which is illustrated in FIG. 1D. At this stage, the free space optical link between the two transceiver units 3 has been established and data can be transmitted between the two transceiver units 3.

The way in which this alignment process is performed in this embodiment will now be described in more detail with reference to FIGS. 2 to 5. FIG. 2 is a schematic block diagram illustrating the main components of the first transceiver unit 3-1 shown in FIG. 1. In this embodiment, the second transceiver unit 3-2 is identical to the first transceiver unit 3-1 and will not, therefore, be described.

As shown in FIG. 2, the transceiver unit 3-1 includes a laser diode 21 which generates a beam 23 of coherent light. In this embodiment, the light generated by the laser diode 21 has a wavelength of 780 nm. The output light beam 23 is then passed through a lens 25, hereafter called the collimating lens 25, which reduces the angle of divergence of the light beam 23 to form the low divergence light beam L₁ shown in FIG. 1. In this embodiment, the collimating lens 25 has a 50 mm diameter and an F-number which is just large enough to collect all the light emitted by the laser diode 21. The collimating lens 25 is also a low aberration lens so that the low divergence light beam L₁ has a relatively uniform wave front. Although the divergence of the emitted light beam L₁ is low, by the time it reaches the second transceiver unit 3-2, it has a beam diameter which is large enough to cover all of the second transceiver unit 3-2.

The transceiver unit 3-1 also includes a receiver lens 31 for receiving the light beam L₂ generated by the second transceiver unit 3-2 (when it has been aligned) and any reflected light beam L₁^{R} received back from the second transceiver unit 3-2. In this embodiment, the receiver lens 31 has a diameter of 100 mm and is designed to direct as much light as possible onto a detector 33. The detector 33 converts the received light into a corresponding electrical signal which varies in accordance with the strength of the received light. The electrical signal is then amplified by an amplifier 35 and filtered by a filter 37 which removes low frequency currents caused by, for example, sunlight. The filtered signal is then input to a central control unit 39 which, as will be described in more detail below, controls the operation of the transceiver unit 3-1.

FIG. 2 also shows that the central control unit 39 is used to output control signals to two motor drivers 45a and 45b which are used to drive the θ and φ stepper motors 47 and 49 respectively. As discussed above, the central control unit 39 outputs appropriate control signals to the motor drivers 45 to cause the transceiver unit 3-1 to scan the transmitted light beam L₁ over the appropriate scanning pattern.

FIG. 2 also shows the above described retro-reflector 28 which forms part of the transceiver unit 3-1 and whose optical axis 30 is parallel with the optical axes 32 and 34 of the collimating lens 25 and the detector lens 31. The retro-reflector 28 has an operating angular range which is at least as great as the angular steering range (θₘₐₓ, φₘₐₓ) of the steering motors and operates to reflect any light that it receives within this operating angular range back in the direction from which it came. In this embodiment, the retro-reflector 28 is formed by a telecentric lens 35 (represented by the lens 36 and the stop member 38 which is optically located at the front focal plane of the telecentric lens) and a planar mirror 40 which is optically located at the back focal plane of the telecentric lens 35.

In this embodiment, during the acquisition mode, the central control unit 39 also outputs control signals for controlling a laser driver 43 so that the light generated by the laser diode 21 is formed by a characteristic sequence of light pulses. In this way, when the transmitted light beam L₁ hits the retro-reflector 28 of the second transceiver unit 3-2, the characteristic sequence of light pulses is reflected back to the first transceiver unit 3-1 and can be detected amongst any other light that is received by the detector 33. At this point, the first transceiver 3-1 is sufficiently well aligned to the second transceiver 3-2 for a communication link to be established, although a small angular offset in a predetermined direction may be applied at this stage, given that the separation of the retro-reflector 28 and the receiver lens 31 is known in advance.

Since both transceiver units 3 simultaneously follow this procedure, either transceiver unit 3 may be the first to achieve alignment with the other. If the first transceiver unit 3-1 is the first to achieve alignment, then it waits for a predetermined period of time to allow the second transceiver unit 3-2 to become aligned with the first transceiver unit 3-1. When this has occurred, the two transceiver units 3 are mutually aligned and the communication link is established. If the first transceiver unit 3-1 is the second transceiver unit to achieve alignment, then when it does so, it immediately receives pulses from the second transceiver unit 3-2 as well as its own pulses that are reflected back from the second transceiver unit 3-2. However, since the sequences of pulses generated by the two transceiver units are different, the first transceiver unit 3-1 can differentiate its own pulses from those of the second transceiver unit and can therefore determine that it has become aligned with the second transceiver unit 3-2.

Once the communication link has been established, data can be transmitted between the two transceiver units 3 carried by the respective optical beams L₁ and L₂. At this stage, data received from the second transceiver unit 3-2 is received by the central control unit 39 and passed out of the transceiver 3-1 via an interface unit 41 to an external processing device (not shown). Similarly, data received from the external processing device is passed to the central control unit 39 via the interface unit 41 where it is used to control the laser driver 43 in order to modulate the light beam L₁ with the data to be transmitted to the second transceiver unit 3-2.

Central Control Unit

FIG. 3 shows in more detail the main components of the central control unit 39 used in this embodiment. As shown, the central control unit 39 includes a controller 71 which operates under control of control software 73 stored in memory 75. As shown by the dashed line in FIG. 3, the controller 71 controls the position of a switch 77 which is arranged to pass either: (i) pulses generated by a pulse generator 79; (ii) the data received from the interface unit 41; or (iii) control data from the controller 71 to the laser driver 43 shown in FIG. 2. During the acquisition mode, the controller 71 causes the pulses generated by the pulse generator 79 to be output to the laser driver 43, whereas after alignment has been achieved, the controller 71 causes the data received from the interface unit 41 or the control data to be passed through to the laser driver 43.

FIG. 4 schematically illustrates the sequence of pulses 80 generated by the pulse generator 79 used in this embodiment. In this embodiment, the peak power P₀ of the pulses is such that the laser diode 21 generates corresponding pulses of laser light having a peak power that is above the eye safety limits for a continuous wave light beam. However, the pulse duration (w) and the repetition period (R) are chosen so that the transmitted light beam L₁ still meets the eye safety limits. As mentioned above, in this embodiment, the pulse generator 79 generates a sequence of pulses which is characteristic of the transceiver unit 3-1. It does this, in this embodiment, by using a unique combination of pulse width (w) and pulse repetition period (R).

During the acquisition mode of operation, the controller 71 generates motor driver control signals θ_{CTRL} and φ_{CTRL} from scan pattern data 81 stored in the memory 75. During this scanning operation, the controller 71 compares the signals received from the filter 37 with pulse pattern data 83 stored in the memory 75 that defines the characteristic sequence of pulses generated by the pulse generator 79. As discussed above, when the controller 71 detects this sequence of pulses in the signals from the filter 37, the controller 71 stops changing the motor control signals θ_{CTR1}, φ_{CTRL}. The controller 71 then waits a predetermined period of time to allow the other transceiver unit 3-2 to become aligned with the first transceiver unit 3-1. If the two transceiver units 3 do not become mutually aligned after this predetermined period of time, the transceiver unit 3-1 resumes its scanning operation, assuming that the reflection that was received was not from the retro-reflector but from some other reflective surface within the scanning range. The scanning operation continues in this manner until the two transceiver units 3-1 and 3-2 are sufficiently aligned with each other that an optical communication link between the two transceiver units 3 can be achieved. At this point, the controller 71 exits the acquisition mode and initiates a data transfer mode in which the controller 71 causes either the data from the interface unit 41 or the control data from the controller 71 to be transmitted to the other transceiver unit.

During this data transfer mode of operation, each transceiver unit 3 will receive the light beam carrying the data transmitted by the other transceiver unit 3 together with the data that it transmitted on the light beam that is reflected back from the other transceiver unit 3. However, since the reflected light beam suffers at least twice the optical loss as the other received light beam, it will only be treated as a noise source in the wanted data signal. Alternatively, the two transceiver units 3 may be arranged to time-division multiplex their transmissions so that there is no interference between the data transmitted by each of the transceiver units 3.

A description has been given above of the way in which an optical communication link is established between two free space optical transceiver units 3. However, in this embodiment, the central control unit 38 has a number of additional features which are arranged to further optimise the alignment and to maintain the alignment during the data transfer mode of operation. These additional features will now be described.

Returning to FIG. 3, the central control unit 39 also includes a received signal strength indicator (RSSI) circuit 81 which is operable to generate a value (hereinafter RSSI value) indicative of the received signal strength. It does this, in this embodiment, by calculating the average AC photocurrent output by the detector 33 after it has been amplified by the amplifier 35 and filtered by the filter 37. The received signal strength indicator circuit 81 averages the AC photocurrent over a relatively long time window compared to the bit period of the communication link. In this way, the RSSI value output by the RSSI circuit 81 will not be affected by any data carried by the received light beam. In this embodiment, the RSSI circuit 81 averages the received signal over a period of 25 microseconds when data is to be transmitted at a rate of 150 MHz. The RSSI value generated by the RSSI circuit 81 is then stored in memory 75 with previous local RSSI values 87. In this embodiment, the previous and the current RSSI values generated by the RSSI circuit 85 are stored in the memory 75.

In this embodiment, the current RSSI value determined by the RSSI circuit 85 is transmitted to the other transceiver unit 3 over an operation and maintenance (OAM) channel that is established between the two transceiver units 3. In this embodiment, this OAM channel is a low bandwidth data channel which is independent of the data to be transmitted between the two transceiver units 3, and enables the transceiver units 3 to exchange information about their states. In this embodiment, the OAM channel is implemented using the same physical optical link as the main data traffic. This is achieved, in this embodiment, by allowing the controller 71 to output the OAM data (such as the current RSSI value) to the switch 77 which will pass the OAM data to the laser driver 43 during an appropriate time slot for the OAM data.

In this embodiment, when the current RSSI value from the remote transceiver unit 3-2 is received at the controller 71, it stores the remote RSSI value 89 in the memory 75 and uses it to refine the alignment with the remote transceiver unit 3. In particular, in this embodiment, the controller 71 introduces a small angular displacement (e.g. of about 0.3 mrad) in the direction in which the transmitted light beam L₁ is output using the stepper motors 47 and 48. It then waits to receive the next RSSI value from the remote transceiver unit 3-2 to determine whether or not there has been an increase in the remote RSSI value. If the remote RSSI value has increased, then the controller 71 introduces a further displacement in the same direction, whereas if there is a decrease in the remote RSSI value, the controller 71 returns the transmitted light beam to its original angular direction and introduces a further displacement in the opposite direction. The controller 71 then continues applying displacements in the two angular directions (θ,φ) until the remote RSSI value cannot be increased further. At this point, the controller 71 determines that it has achieved an optimum alignment of the transceiver unit 3-1 with the other transceiver unit 3-2 and stops varying the transmitting direction of the transmitted light beam L₁. A similar procedure is also carried out in the remote transceiver 3-2 using the RSSI values transmitted by the transceiver 3-1.

Once the alignment has been optimised in this way, the two transceiver units 3 continue to transmit their RSSI values to each other and the controller 71 monitors the remote RSSI values so that it can detect if it drops by more than a predetermined value (indicating that either the optical loss between the two transceiver units 3 has increased or that the relative alignment of the transceiver units 3 has changed). Such a drop in the remote RSSI value is illustrated in the plot shown in FIG. 5 between the RSSI value at time tₛ and the next RSSI value at time tₙ₊₁. In this embodiment, the controller 71 monitors for this drop by subtracting the previous remote RSSI value from the current remote RSSI value and by comparing the difference (δ_{RSSr}) with a predetermined threshold which is stored with other thresholds and system constants 91 in the memory 75. If the controller 71 detects that there has been a sudden change in the remote RSSI value, then it restarts the alignment optimisation routine described above.

As those skilled will appreciate, the local RSSI value generated at each transceiver unit 3 must be above a predetermined value in order to achieve a desired signal to noise ratio and hence bit error rate. However, it is also advantageous to maintain the transmitted laser power at the minimum level necessary to achieve the desired link performance (signal to noise ratio and hence bit error rate). Therefore, in this embodiment, the controller 71 also uses the remote RSSI value to control the power of the light beam generated by the laser diode 21. In particular, the controller 71 outputs a control signal 93 to the laser driver 43 to control the power of the light beam generated by the laser diode 21 to the point where the remote RSSI value is just sufficient (including a predetermined margin) for successful link operation. By doing this, each of the transceiver units 3 effectively ensures that the light in the region around the remote transceiver unit 3 (the “overspill” region for light not collected by the transceiver aperture) is at as low a level as possible.

In this embodiment, each of the transceiver units 3 also monitors the local RSSI levels that it generates, again to detect if there is a rapid decrease in its value. If there is a rapid decrease, then this may either be due to a misalignment of the transceiver units (for example due to one of the transceiver units 3 having been knocked) or due to an interruption of the beam (which could be potentially hazardous if it is a person's head that has interrupted the beam). In this embodiment, if the controller 71 detects that the local RSSI value has decreased significantly from one RSSI value to the next, then the controller 71 outputs a control signal to the laser driver 43 to reduce the transmitted power level of the laser beam L₁ to an eye safe level in order to protect any person interrupting the laser beam. The controller 71 then enters a pulsing mode of operation in which it causes pulses of light to be generated by the laser diode 21 (in a similar way to the pulses that are generated in the acquisition mode) in order to attempt to re-establish the link. If the link is not re-established after a predetermined period of time, the controller 71 concludes that one or more of the transceiver units 3 has been mechanically misaligned and it reinitiates the acquisition mode in order to scan the transmitted light beam L₁ over the scanning range in order to try to re-establish the link.

### Modifications and Alternative Embodiments

In the above embodiment, separate transmission and reception optics were provided in each of the transceiver units. As those skilled in the art will appreciate, common optics may be used for the transmission and reception beams. In this case, an appropriate beam splitter will have to be used in order to separate the received beam from the transmitted beam. Such an embodiment is illustrated in FIG. 6 in which like reference numerals have been used to designate like elements. As shown in FIG. 6, the main difference in this embodiment is the use of common receiving and transmission optics 101 and 103 and the provision of a beam splitter 105 to reflect the received beam down towards the detector 33.

In the above embodiments, the retro-ref lector that was used was a telecentric retro-reflector. As those skilled in the art will appreciate, other types of retro-reflectors may be used, such as a conventional corner-cube or cat's eye reflector. However, a problem with retro-ref lectors of this type is that the beam divergence of the reflected beam is at least as large as that of the incident beam. Since the retro-reflected beam travels twice the link separation, this beam divergence can introduce a significant additional attenuation for the reflected beam during the alignment procedure. The only way to partially counter this effect when using such conventional retro-reflectors is to use a retro-reflector with a large collection aperture which is then bulky and expensive. However, the use of a telecentric retro-reflector such as those used in the first and second embodiments described above has the advantage that the retro-reflected beam can be re-focussed using the telecentric lens in order to give a retro-reflected beam divergence that is smaller than the incident beam divergence. Therefore, with such a telecentric lens retro-ref lector, the overall loss for the retro-reflected beam may be significantly reduced without the need for a large collection aperture. The use of the telecentric retro-reflector also allows a larger aperture to be realised at lower cost than a corresponding corner-cube retro-reflector.

In the first and second embodiments described above, the retro-reflector included a telecentric lens and a planar reflector. In an alternative embodiment, the planar reflector may be replaced with a reflecting modulator which can be driven with a signal representing a unique identification for the transceiver unit (for example its serial number in binary code). This allows the transceiver unit that receives the retro-reflected beam during the alignment process to verify that the retro-reflection is being generated by a transceiver unit (or in fact a particular transceiver unit). This prevents a transceiver unit from erroneously locking onto a spurious reflection not generated by a transceiver unit, or from locking onto an unwanted transceiver unit in the case where a number of transceiver units are operating simultaneously in the same angular region. Such an embodiment is illustrated in FIG. 7 as a modification of the embodiment shown in FIG. 6. As shown, the main difference of the transceiver unit shown in FIG. 7 is that separate code data 111 is provided which drives a reflecting modulator 113 in order to apply the code onto the received laser beam. Various different types of optical modulators may be used to form the reflecting modulator 113. The reader is referred to WO 98/35328 which describes a number of different retro-reflecting modulators which may be used.

In the above embodiments, during the acquisition mode, each of the transceiver units transmitted a characteristic sequence of pulses to the other transceiver unit. Such characteristic pulses were used so that each of the transceiver units could differentiate between their own pulses and the pulses transmitted by the other transceiver unit. As those skilled in the art will appreciate, this is not essential. Each transceiver unit may be arranged to align itself with the other in a time-sequential manner such that, for example, the second transceiver unit does not begin to try to align itself with the first transceiver unit until the first transceiver unit has aligned itself with the second transceiver unit. In this case, there is no need to differentiate the pulses transmitted by the two transceiver units. However, as those skilled in the art will appreciate, it is preferred to operate the two transceiver units simultaneously as this reduces the time required to achieve alignment between the two transceiver units. Therefore, it is preferred that both of the transceiver units transmit a unique sequence of pulses to the other during the acquisition mode.

In the first embodiment described above, a unique sequence of pulses was determined by using a unique pulse-width and a unique pulse repetition period. As those skilled in the art will appreciate, a unique set of pulses may be obtained by having only a unique pulse-width or only a unique pulse repetition period. Alternatively, each transceiver unit may be arranged to generate its own pseudo-random sequence of pulses which it can correlate with the received signal to identify if it is receiving a reflected version of the transmitted pulses. The use of such pseudo-random sequences of pulses has the advantage that the transceiver unit will be able to detect the sequence in the reflected signal even if the signal-to-noise ratio of the reflected signal is very low. However, the use of such pseudo-random pulse sequences increases the complexity and hence cost of the transceiver units. Alternatively, instead of transmitting a unique sequence of pulses, each of the transceiver units may be arranged to transmit the current RSSI value generated by its RSSI circuit. In this case, each transceiver unit would look for reflected light carrying the same RSSI value.

In the first embodiment described above, the transceiver unit has transmitted the RSSI values to the other transceiver units over an OAM channel on the optical link established between the two transceiver units. In the above embodiments, this OAM channel was provided as a time slot within the data channel. As those skilled in the art will appreciate, other techniques can be used to transmit the OAM data to the other transceiver unit. For example, the OAM data may be used to modulate the phase of the data clock and then transmitted simultaneously with any data. Alternatively, if no data is to be transmitted, then the OAM data can be transmitted as an amplitude modulation of the transmitted light beam. Further, as those skilled in the art will appreciate, this OAM channel may be established over a different communication link, such an RF link that is established between the two transceiver units. However, this is not preferred, since additional transmission and reception circuitry will be required to establish this link.

In the above embodiment, it is assumed that the initial alignment achieved using the steering motors would be sufficient to align the two transceivers so that a high bandwidth data channel can be formed between the two transceivers. However, on some occasions, this initial alignment may not be that accurate, making it impossible for a high bandwidth data channel to be established. However, as long as some light is received at the other transceiver unit, the low bandwidth OAM channel should be able to be established (as it requires lower signal to noise ratio because of its lower data rate). Therefore, the above described alignment optimisation technique can then be used using the RSSI values transmitted from the other transceiver unit to optimise the alignment between the two transceiver units. The full bandwidth data channel can then be established between the two transceiver units once they are accurately aligned.

In the above embodiments, the optical access of the retro-reflector was aligned with the optical access of the transmitter and receiver optics of the transceiver unit. As those skilled in the art will appreciate, this is not essential. All that is needed is that the field of view of the retro-reflector must be large so that the other transceiver unit will be within its field of view.

In the above embodiments, stepper motors were used to rotate each of the transceiver units about two orthogonal axes. As those skilled in the art will appreciate, various techniques can be used to steer the transmitted beams over the steering range. For example, the beams may be steered by rotating a pair of refractive prisms or by reflecting the beam off two mirrors which can be rotated about different axes. Other ways in which the transmitted beam may be steered will be apparent to those skilled in the art and will not be described further. However, the advantage of steering the beam by mechanically moving the transceiver unit is that the alignment between the optical axes of the retro-ref lector and the transmission and reception optics can be maintained.

In the first embodiment described above, each of the transceiver units monitored the local RSSI values and the remote RSSI values for sudden changes between successive values. As those skilled in the art will appreciate, the transceiver units may be arranged to monitor a longer history of the RSSI values before making any decision about loss of alignment or interruption of the optical beams, in order that spurious readings do not interfere with the operation of the transceiver units.

In the above embodiments, each of the transceiver units transmitted laser light at a wave length of about 780 nm. As those skilled in the art will appreciate, other wave lengths could be used. Further, it is not essential to use a laser diode. Other light emitting devices may be used.

Although a point-to-point signalling system has been described, this point-to-point communication link may form part of a larger communications network.

1-25. (canceled)

26. A free space optical signaling system comprising first and second free space optical transceiver units, wherein each transceiver unit comprises:
an optical transmitter operable to output a light beam into free space;
a beam steerer operable to steer the transmitted light beam within a steering range of the beam steerer;
a reflector operable to reflect light in a direction from which the light is received;
a processor operable to process the signal output by said optical receiver to determine if the light received by said receiver includes light that is generated by said optical transmitter and which is reflected by the reflector of the other transceiver unit; and
a controller operable to control the beam steerer in dependence upon a determination made by said processor;
wherein the reflector of at least one of the transceiver units comprises a telecentric lens.

27. A system according to claim 26, wherein the reflector of each transceiver unit comprises a telecentric lens and a planar reflector.

28. A system according to claim 26, wherein an optical axis of said telecentric lens is substantially parallel with an optical axis of said optical transmitter.

29. A system according to claim 26, wherein the optical axes of said telecentric lens and said optical transmitter are substantially parallel to an optical axis of said optical receiver.

30. A system according to claim 26, wherein said controller is operable to control said beam steerer in order to scan the transmitted light beam over a predetermined scan pattern until said processor determines that the received light includes light that is generated by the optical transmitter and which is reflected by the reflector of the other optical receiver.

31. A system according to claim 26, wherein each transceiver unit further comprises a received signal strength indicator circuit which is operable to determine a value indicative of the strength of the optical signal received by said optical receiver.

32. A system according to claim 26, wherein each transceiver unit is operable to transmit the determined received signal strength indicator value to the other transceiver unit.

33. A system according to claim 26, wherein the reflector of said at least one transceiver unit comprises a reflective modulator and further comprising a code generator operable to apply a code to said reflective modulator to impose the code on the light to be reflected by said reflector.

34. A system according to claim 26, wherein said optical transmitter is operable to transmit a predetermined sequence of optical pulses and wherein said processor is operable to determine if said received signal includes a reflected version of the predetermined sequence of optical pulses generated by said optical transmitter.

35. A free space optical signaling system comprising first and second free space optical transceiver units, wherein each transceiver unit comprises:
an optical transmitter operable to generate and to output a light beam into free space;
a beam steerer operable to steer the transmitted light beam within a steering range of the beam steerer;
a reflector operable to reflect light in a direction from which the light was received;
a detector operable to detect light generated by said optical transmitter that has been reflected by the reflector of the other transceiver unit; and
a controller operable to control the beam steerer in dependence upon a detection made by said detector.

36. A free space optical signaling system comprising first and second free space optical transceiver units, wherein each transceiver unit includes an acquisition mode in which it scans a transmitted optical beam over a predetermined scanning range to try to establish a free space optical link with the other transceiver unit and, once established, a data transmission communication mode in whichstatus data transmitted from the other transceiver unit is used to optimize an alignment between first and second transceiver units.

37. A signaling system according to claim 36, wherein said status data is indicative of a received signal strength received at the other transceiver unit.

38. A free space optical signaling system comprising first and second free space optical transceiver units, wherein at least one of the transceiver units comprises:
an optical transmitter operable to generate and to output a light beam into free space towards the other transceiver unit;
an optical receiver operable to receive light from the other transceiver unit;
a received signal strength indicator circuit which is operable to determine a value indicative of the strength of the optical signal received by said optical receiver; and
a power control circuit operable to control the power of the light beam generated and output by said optical transmitter in dependence upon a variation in the received signal strength indicator value determined by said indicator circuit.
